(19) United States
(12) Patent Application Publication
(10) Pub. No.: US 2009/0122675 A1
(43) Pub. Date: May 14, 2009

(54) Method for determining optimal operating parameters for reading or writing a storage medium

(75) Inventors: Tony P. Van Endert, Taipei (TW); Maarten Kuijper, Taipei (TW)

Correspondence Address: BACON & THOMAS, PLLC, 625 SLATERS LANE, FOURTH FLOOR, ALEXANDRIA, VA, 22314-1176, US

(73) Assignee: PHILIPS & LITE-ON DIGITAL SOLUTIONS CORPORATION, Taipei (TW)

(21) Appl. No.: 11/984,133

(22) Filed: Nov. 14, 2007

(51) Int. Cl. G11B 7/00; G11B 20/18

(52) U.S. Cl. 369/53.2

(57) ABSTRACT

A method for determining optimal operating parameters for reading or writing a storage medium, with the consideration of failed experiment. In an embodiment of the invention, if one of a set of experiments, executed within pre-defined ranges with respect to two parameters, leads to an invalid characteristic measurement value, and the corresponding values of the two parameters occur substantially at ends of the respective ranges, at least one search operation is determined according to the failed experiment(s) and a new set of experiments is generated according to the previous set of experiments and the search operation to avoid the failed experiment(s). The new set of experiments can result in more reliable optimal operating parameters.

### BACKGROUND OF THE INVENTION

1. Field of the Invention

The invention relates in general to a method for determining operating parameters for reading or writing a storage medium, and more particularly to a method for determining a set of experiments, which are expected to be more reliable than a previous set of experiments, in finding optimal operating parameters for reading or writing a storage medium.

2. Description of the Related Art

For optical storage media, self-learning operating parameter tuning algorithms have been developed to determine optimal operating parameters, such as the optimal write strategy parameters or the optimal servo parameters, for writing or read data into or from a storage medium even though the storage medium is unknown, i.e. not the one listed in a predetermined media list in the firmware of a storage medium drive. For example, a self-learning operating parameter tuning technology, called Solid Burn developed by Philips Electronics, has been used in some storage medium drives in the market for optimizing write strategy parameters to reach the optimal possible write performance for each different storage media.

The operating parameter of a storage medium drive is the way in which it writes to or read from a blank storage medium. Traditionally, these operating parameters are predetermined by the medium manufacturer and stored in the medium information. However, the drive manufacturer creates a list in the firmware of the drive, for a number of different media known before the production of the drive. However, as new storage media regularly coming to market, the way to ensure an up-to-date media list for best writing and reading quality is to update their storage medium drives with the latest firmware. Such approach, in fact, is undesirable operation since it is inconvenient for the consumers.

This self-learning operating parameter tuning technology executes a series of tests on an ‘unknown’ storage medium to determine the optimal operating parameters to write or read data. In contrast, a traditional storage medium drive, without such a self-learning approach, would write data on any new storage media that are not in the media list of the drive using a standard write strategy and read data on any new storage media that are not in the media list of the drive using standard servo parameters. This could result in lower operating speeds and reducing storage media playability and writing quality.

Specifically, for a certain step in self-learning operating parameter tuning technology, for example Solid Burn, a number (e.g. 13) of experiments are done where two write strategy parameters will be changed at the same time. For every experiment, a characteristic measurement value, such as jitter value, will be measured. From the characteristic measurement values, jitter values, a fit to a second order model will be made. All these experiments have to be successful; otherwise the model that will be made is not correct and becomes unreliable.

Also in reading operation, a self-learning operation parameter tuning technology is done first to determine the optimal servo parameters, such as the focus offset and the spherical aberration, for optimizing the reading performance. Similar to Solid Burn, a number of experiments are done where two servo parameters will be changed at the same time. For every experiment, a characteristic measurement value, such as HF-jitter value, will be measured. From the characteristic measurement values, HF-jitter values, a fit to a second order model will be made. All these experiments have to be successful; otherwise the model that will be made is not correct and becomes unreliable.

In general, operating parameters of some storage media, especially DVD±R media, are not sensitive with respect to bad characteristic measurement values if experiments are executed within wide pre-defined ranges. This means that there is no need to recover bad characteristic measurement values. In this way, the chosen ranges of operating parameters are valid for different medium manufacturers.

However, such characteristics of DVD±R media may not apply to all new DVD media and other new optical storage media with technology different from that of the DVD±R media. Currently, Blu-ray (BD-R) media have been available in the market to provide higher capacity and performance than conventional DVD media. To maximize capacity and performance, the main optical system parameters of the BD-R media include a laser diode with a wavelength 405 nm and an objective lens with a NA of 0.85. With respect to operating parameters tuning, BD-R media are much more sensitive compared to conventional DVD media. Accordingly, the conventional self-learning approach based on such storage media may be unreliable.

### SUMMARY OF THE INVENTION

The invention is directed to a method for determining optimal operating parameters for reading or writing a storage medium, with the consideration of failed experiment. In an embodiment of the invention, if at least one of a set of experiments, executed within pre-defined ranges with respect to two parameters, leads to an invalid characteristic measurement value, at least one search operation is determined according to the distribution of the failed experiments. A new set of experiments is then generated according to the previous set of experiments and the at least one search operation so that the new set of experiments generated in this way is to result in more reliable optimal operating parameters.

According to a first aspect of the present invention, a method for determining a set of experiments in finding optimal operating parameters for reading or writing a storage medium is provided. The method includes the following steps. First, for a first set of experiments in a parameter space with respect to a first parameter and a second parameter, a set of characteristic measurement values is determined according to an incoming signal from the storage medium, on which the first set of experiments is performed, and it is determined whether the characteristic measurement values are valid or not. If at least one invalid experiment exists in the first set of experiments, where one invalid experiment corresponds to a characteristic measurement value which is invalid, a second set of experiments is generated according to the first set of experiments in order for the second set of experiments to exclude the at least one invalid experiment. The generating step includes following. At least one search operation is determined according to distribution of the at least one invalid experiment in the parameter space in order to map the parameter space onto a new parameter space. The second set of experiments on the new parameter space is generated, wherein the first set of experiment is mapped onto the new parameter space according to the at least one search operation so that the second set of experiments excludes the at least one invalid experiment.

According to a second aspect of the present invention, a method for determining optimal operating parameters for reading or writing a storage medium is provided. The method includes the following steps. (a) A first set of experiments with respect to a first parameter and a second parameter is determined, wherein each of the first set of experiments being associated with values of the first and second parameters. (b) Each of the first set of experiments is performed by setting of the associated values of the first and second parameters. (c) for a first set of experiments in a parameter space with respect to a first parameter and a second parameter, a set of characteristic measurement values is determined according to an incoming signal from the storage medium, and determining whether the characteristic measurement values are valid or not. (d) If at least one invalid experiment exists in the first set of experiments, where one invalid experiment corresponds to a characteristic measurement value which is invalid, a second set of experiments is determined according to the first set of experiments in order for the second set of experiments to exclude the at least one invalid experiment. The generating step includes: determining at least one search operation according to distribution of the at least one invalid experiment in the parameter space in order to map the parameter space onto a new parameter space; and generating the second set of experiments on the new parameter space, wherein the first set of experiment is mapped onto the new parameter space according to the at least one search operation so that the second set of experiments excludes the at least one invalid experiment. (e) The second set of experiments is performed on the storage medium and obtaining characteristic measurement values for the second set of experiments. (f) Optical operating parameters with respect to the first and second parameters is determined according to the characteristic measurement values for the second set of experiments.

The invention will become apparent from the following detailed description of the preferred but non-limiting embodiments. The following description is made with reference to the accompanying drawings.

### BRIEF DESCRIPTION OF THE DRAWINGS

FIG. 1A is a flowchart illustrating a method for determining optimal operating parameters for a storage medium, according to an embodiment of the invention.

FIG. 1B is a flowchart illustrating an example of the step of determining at least one search operation according to distribution of the at least one invalid experiment.

FIG. 2 is a graph of a distribution pattern of points in a parameter space, wherein the points represents a first set of experiments with respect to two parameters.

FIG. 3 is a graph of a distribution pattern of points in a new parameter space by a shift operation.

FIG. 4 is a graph of a distribution pattern of points in a new parameter space by a contraction operation.

FIG. 5 is a graph of a distribution pattern of points in a new parameter space by a rotation operation.

### DETAILED DESCRIPTION OF THE INVENTION

Regarding finding optimal operating parameters for new storage media such as BD-R discs by a self-learning operating parameter tuning method, as the new storage media may be much more sensitive with respect to the operating parameters change, it will be reflected in failure to obtain a valid characteristic measurement value, thus resulting in an unreliable self-learning operating parameter tuning method.

For example, a characteristic measurement value, e.g. a jitter value, is used for determining the optimal operating parameters, e.g. optimal write strategy parameters, for writing storage media. Each jitter value for each experiment has to be valid to construct a reliable model. Specifically, a high-frequency phase-locked loop (HF PLL) of a drive must be locked to the signal received from the medium, i.e. the incoming signal for measurement of jitter, i.e. read action. As an example, one jitter measurement value fails at a certain experiment, i.e. the HF-PLL is unable to lock on the incoming signal due to poor write performance, as shown in TABLE 1 below. In TABLE 1, the average jitter measurement values in percentage (%) for a number of experiments, e.g. 13 experiments, associated with two parameters, e.g. power P in mW and pulse width T_{MP}_{_{—}}_{P} in ns, are shown. It is noted that one experiment fails. The chance to have PLL unlock is the highest at a “corner” of TABLE 1 where the two parameters for a certain experiment are substantially at ends of their respective ranges.

TABLE 1

| | | Power (mW) | | | | |
|---|---|---|---|---|---|---|
| Average jitter | | 230 | 252 | 275 | 298 | 320 |
| T_{MP}_{_{—}}_{P} | 9.25 | HF PLL | | 17.0% | | 18.8% |
| (ns) | | Out of | | | | |
| | | lock | | | | |
| | 9.8125 | | 12.2% | | 14.2% | |
| | 10.375 | 14.1% | | 11.7% | | 15.7% |
| | 10.9375 | | 11.1% | | 13.7% | |
| | 11.5 | 17.1% | | 13.6% | | 19.0% |

Because of the failed jitter measurement value in the “corner”, i.e. the parameter point (230, 9.25), the outcome of the second order model fit becomes highly unreliable. Such parameter point should be avoided in order to determine optimal write strategy parameters.

In another example, two jitter measurement values fail at two certain experiments, specifically, on an “edge” of the distribution pattern of the experiments, as shown in TABLE 2 below.

TABLE 2

| Average | | Power (mW) | | | | |
|---|---|---|---|---|---|---|
| jitter | | 263 | 298 | 333 | 368 | 403 |
| T_{MP}_{_{—}}_{P} | 8 | PLL | | PLL | | 24% |
| (ns) | | Out of | | Out of | | |
| | | lock | | lock | | |
| | 9 | | 16% | | 16% | |
| | 10 | 16% | | 12% | | 16% |
| | 11 | | 13% | | 16% | |
| | 12 | 24% | | 17% | | 22% |

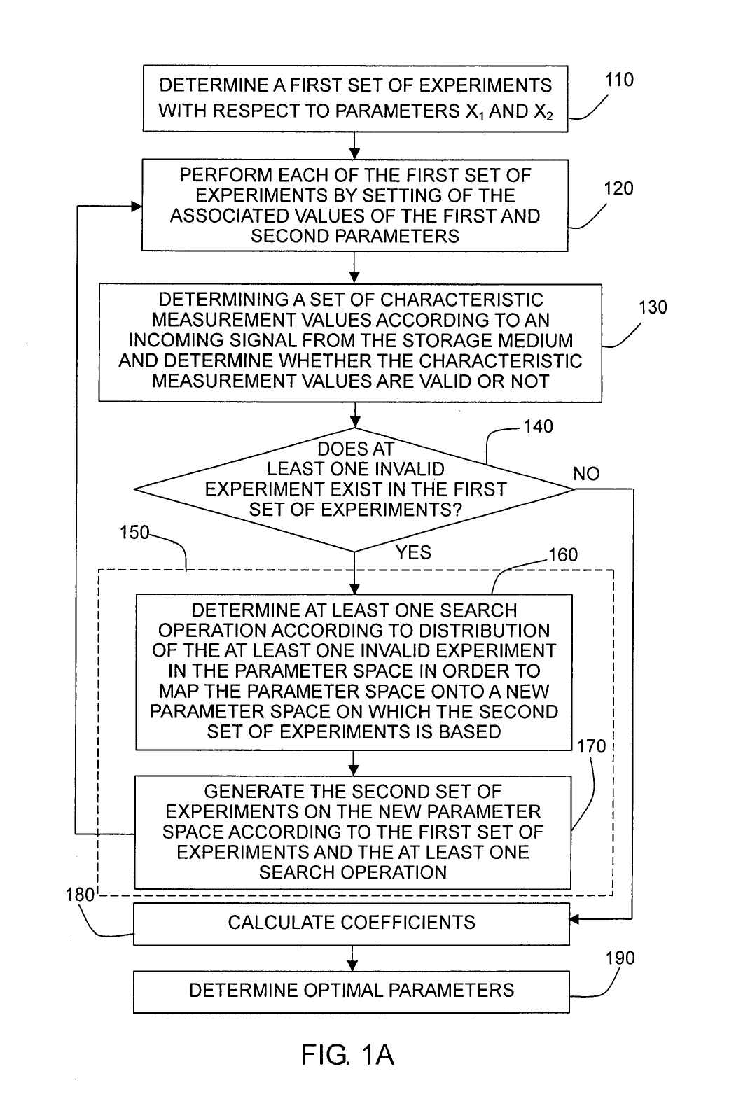

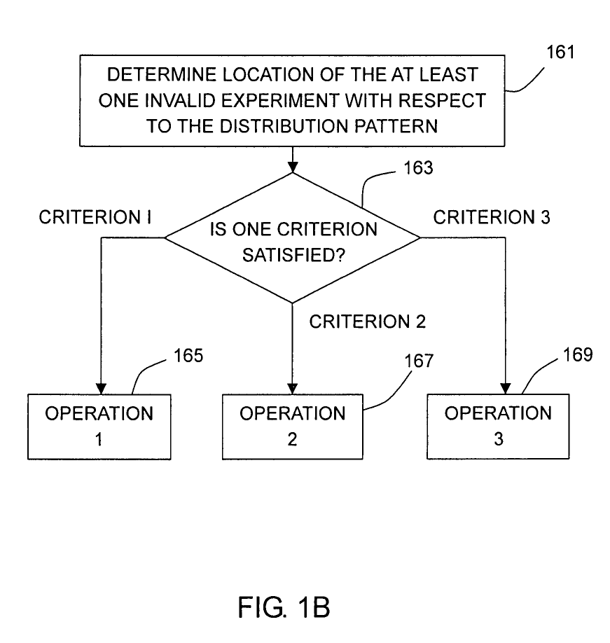

Referring to FIG. 1A, a method for finding optimal operating parameters of a storage medium for reading data from the storage medium or writing data on the storage medium is shown in flowchart form, according to a preferred embodiment of the invention. When at least one parameter point that leads to an invalid characteristic measurement value is discovered, a new set of experiments is determined according to the previous set of experiments in order to avoid at least the parameter point. Hence, any found failed characteristic measurement values, such as those illustrated in TABLE 1 or TABLE 2 would not occur when performing the new set of experiments. In other words, optimal operating parameters can then be determined according to the outcome of the second order model fit and are expected to be more reliable.

In a first step 110 of FIG. 1A, a first set of experiments in a parameter space with respect to a first parameter and a second parameter is determined. Each of the first set of experiments is associated with values of the first and second parameters, and the values of the first parameter are in a first range and the values of the second parameter being in a second range. In step 120, each of the first set of experiments is performed by setting of the associated values of the first and second parameters.

In step 130, for the first set of experiments in the parameter space, a set of characteristic measurement values is determined according to an incoming signal from the storage medium and determining whether the characteristic measurement values are valid or not. Specifically, for example, the recorded data on the storage medium is read by receiving an incoming signal from the storage medium.

In step 140, it is determined whether at least one invalid experiment exists in the first set of experiments, where one invalid experiment corresponds to a characteristic measurement value that is invalid. If so, the method proceeds to step 150 for generating a second set of experiments according to the first set of experiments in order for the second set of experiments to exclude (i.e. to avoid) the at least one invalid experiment. Step 150 includes at least step 160 and step 170.

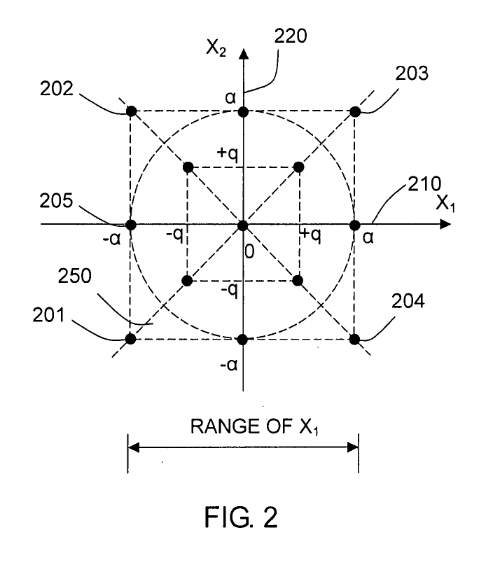

In step 160, at least one search operation is determined according to distribution of the at least one invalid experiment in the parameter space in order to map the parameter space onto a new parameter space on which the second set of experiments is based. The first set of experiments has a distribution pattern in the parameter space. For example, 13 experiments based on code q=0.5 and α=1 are taken, meaning a normalization of the parameters (α=1 means that the total range is used; q=0.5 means that half of the range is used), as illustrated in FIG. 2. Referring to FIG. 2, 13 points representing 13 experiments are associated with 13 pairs of values of two parameters: a first parameter denoted by X₁ and a second parameter denoted by X₂ as illustrated in TABLE 1 or TABLE 2. The detailed description about setting anew parameter space will be described latter.

Referring to FIG. 1B, step 160 can be implemented, for example, by including step 161 to determine the location of the at least one invalid experiment in view of the distribution pattern. That is, the location of each valid experiment in the parameter space is analyzed in view of the distribution pattern. In this regard, the analysis of the location can be performed in view of different criteria. For example, the analysis can be made to determine whether the at least one invalid experiment is substantially in a corner or an edge of the distribution pattern of the first set of experiments. In step 163, if one of a number of criteria, for example, criterion 1, is satisfied, one of the operations, for example, operation 1, is determined, as indicated in step 165. Further, a criterion can include a number of different conditions, such as the location determined in step 161 or other conditions related to valid experiments. As an example, there are three search operations: a shift operation, a contraction operation, and a rotation operation, as illustrated in step 165, 167, and 169, which will be discussed subsequently.

In step 170, the second set of experiments is generated on the new parameter space according to the first set of experiments and the at least one search operation, wherein the first set of experiment is mapped onto the new parameter space according to the at least one search operation so that the second set of experiments excludes the at least one invalid experiment.

After step 170, the current set of experiments, i.e. the second set of experiments, does not include the one of the first experiment whose characteristic measurement value is invalid, i.e. the invalid experiment(s). Thus, the method according to the preferred embodiment can further perform the current set of experiments and then obtain the characteristic measurement values for the current set of experiments, which can be done by using steps 120 and 130, for example. If the characteristic measurement values obtained in this way are checked to be valid, for example, as checked by step 140, the method proceeds to step 180 to calculate coefficients of a response function using the valid characteristic measurement values and the values of the first and second parameters of the second set of experiments. After the coefficients are calculated, optimal first and second parameters of the response function can be obtained in step 190.

In the following, an example of a first set of experiment is taken to illustrate the above embodiment of the method, with the concepts of normalization of parameters and parameter space for the sake of illustration. It is noticed that other representations of the experiments and different parameter combinations can also be applied to the implementation according to the embodiment of the method.

In step 110, a first set of experiments is determined. For example, 13 experiments based on code q=0.5 and α=1 are taken, meaning a normalization of the parameters (α=1 means that the total range is used; q=0.5 means that half of the range is used), as illustrated in FIG. 2. Referring to FIG. 2, 13 points representing 13 experiments are associated with 13 pairs of values of two parameters: a first parameter denoted by X₁ and a second parameter denoted by X₂ as illustrated in TABLE 1 or TABLE 2, wherein the first set of experiments, as well as a new set of experiments to be generated, is used in a design of experiments method. In other examples, 9+4n experiments, where n is a nonzero integer, for instance 9 experiments, can be taken as well, wherein for a specific value of n, a set of (9+4n) experiments has a distribution pattern in the parameter space as a grid of points including a central point.

In addition, as mentioned above, there are three search operations for obtaining a new set of experiments: a shift operation, a contraction operation, and a rotation operation, according to one embodiment of the invention. The shift operation is to shift the parameter space by a distance in a direction away from the edge so that the new set of experiments on the new parameter space excludes the at least one invalid experiment. The contract operation is to make a dynamic range of one of the first and second parameters smaller in the new parameter space by a ratio. The rotation operation is to rotation the parameter space by an angle so that the new set of experiments on the new parameter space excludes the at least one invalid experiment. In order to generate the second set of parameters to avoid the invalid experiments distributed in different situations, the search operation determined in step 150 may be one operation or a combination of two or more of the operations.

The following provides three example of using these operations in different situations.

In a first example, if the at least one invalid experiment is substantially on an edge of the distribution pattern of the first set of experiment, the at least one search operation is determined as including a shift operation to shift the parameter space by a distance in a direction away from the edge so that the new set of experiments on the new parameter space excludes the at least one invalid experiment.

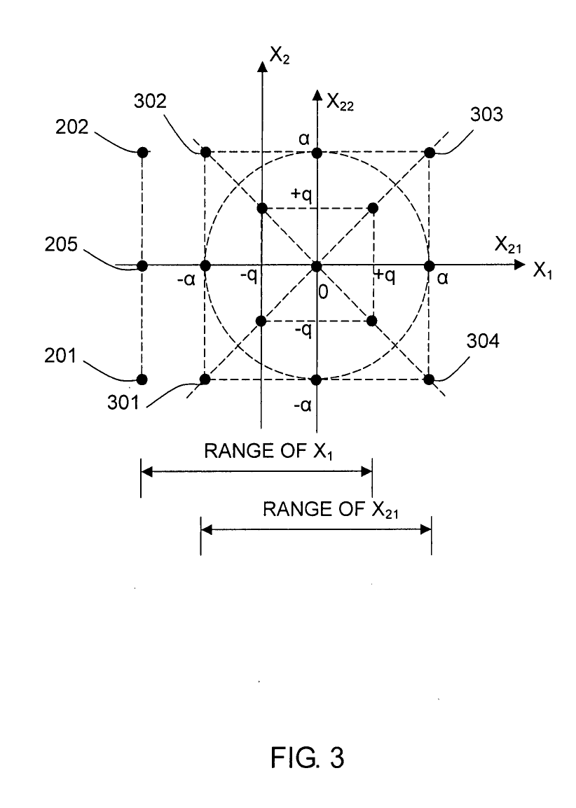

Referring to FIGS. 2 and 3, it is supposed that one edge, e.g. the left edge on the distribution pattern of the first set of experiments in FIG. 2, includes points corresponding to an invalid characteristic measurement value, e.g. point 205 within the edge and other points such points 201 or 202, wherein this case corresponds to the case as illustrated in TABLE 2. In this case, a shift operation by a distance of q, for example, in the positive direction of X₁ away from the edge (including points 201, 202, 205) is determined. As illustrated in FIG. 3, the second set of experiments excludes the edge with the valid point 205. In addition, one area of parameter space is explored in FIG. 3, wherein the range of X₂₁ is shifted to the right by a distance of q. This search operation can be used, preferably, when the valid experiments (points) show a slope which is too flat to obtain optimal parameters.

In a second example, if the at least one invalid experiment is substantially on an edge of the distribution pattern of the first set of experiment and the edge is substantially parallel to an axis of the other one of the first and second parameters in the parameter space, the at least one search operation is determined as including a contraction operation to contract the parameter space by a ratio in a direction away from the edge so that the new set of experiments on the new parameter space excludes the at least one invalid experiment.

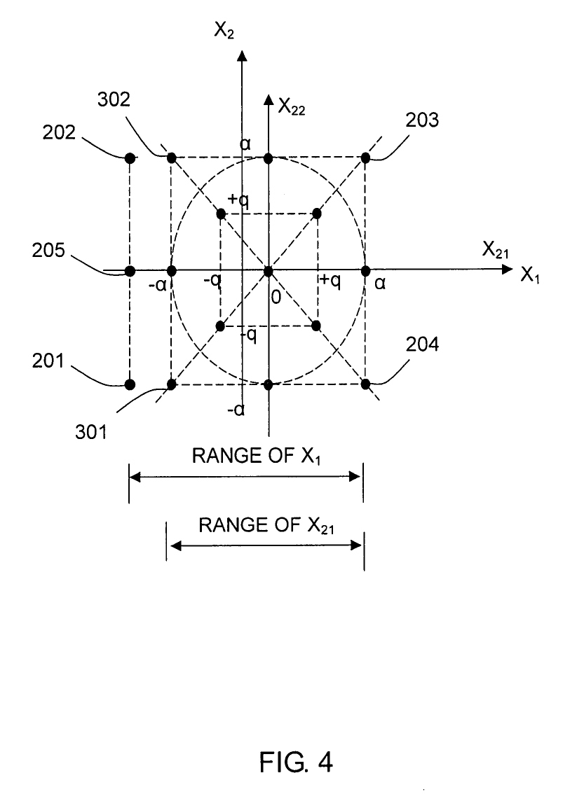

Referring to FIGS. 2 and 4, if one edge, e.g. the left edge on the distribution pattern of the first set of experiments in FIG. 2, includes points corresponding to an invalid characteristic measurement value, e.g. point 205 within the edge and other points such points 201 or 202, wherein this case corresponds to TABLE 2. In this case, a contraction operation by a ratio to contract the range of X₁ to a range of X₂₁ away from the edge (including points 201, 202, 205) is determined. As illustrated in FIG. 4, the second set of experiments (including points 301, 302, 203, 204) excludes the edge with the valid experiment 205. This search operation can be used, preferably, when a sufficient dynamic range is found for one of the first and second parameters, e.g. for the first parameter X₁ in the above example, so that the right boundary, i.e. the edge indicated by points 203 and 204, is not adapted, and the range of X₂₁ is contracted by a ratio of the range of X₁ in the positive direction of X₁. In this case, no unknown area of parameter space is explored.

In a third example, if the at least one invalid experiment is substantially in only at least one corner of the distribution pattern of the first set of experiment, the at least one search operation is determined as including a rotation operation to rotation the parameter space by an angle so that the new set of experiments on the new parameter space excludes the at least one invalid experiment.

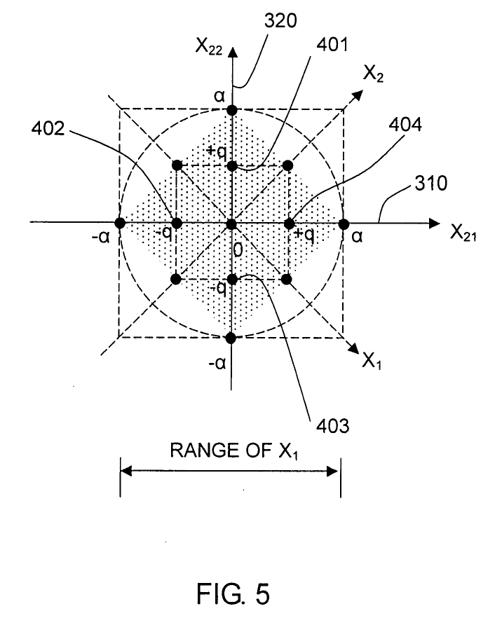

Referring to FIG. 2, if one of the corner points 201, 202, 203, and 204 leads to an invalid characteristic measurement value, as indicated in TABLE 1, a rotation operation by an angle of 45° counterclockwise is determined. As will be illustrated in the following, the second set of experiments is shown in FIG. 5, where the failed experiment(s), e.g. corner point 201, is excluded (or avoided) in the new parameter space with respect to parameters X₂₁ and X₂₂.

For the sake of illustration, the above-mentioned experiments in TABLE 1 are taken and can be represented as normalized parameters in FIG. 2, wherein the first parameter X₁ represents the normalized power P and the second parameter X₂ represents the normalized pulse width T_{MP}_{_{—}}_{P}. In TABLE 1, the values of the two parameters P and T_{MP}_{_{—}}_{P} are in a first range from 230 to 320 and a second range from 9.25 to 11.5, respectively. As an example, the first range is normalized as a range of −1 to 1 and the second range as a range of −1 to 1. The normalization of parameters in TABLE 1 results in a number of points representing the first set of experiments in a parameter space with respect to the first parameter X₁ and the second parameter X₂ in FIG. 2. As can be observed, the first set of experiments in FIG. 2 has a distribution pattern as a grid of points in this example. In addition, in TABLE 1, a region near the parameter point (230, 9.25), which leads to valid characteristic measurement value, corresponds a “corner” of the distribution pattern in FIG. 2, as indicated by a point 201. Further, any point in the parameter space in FIG. 2 can be mapped to “real” parameters, according to the first and second ranges, for example, by linear interpolation.

Regarding the above example of the first set of experiments, after steps 120, 130, and 140, an invalid characteristic measurement value of one experiment is determined. In other words, at least one failed (or invalid) experiment is found in step 140, e.g. an invalid jitter value resulting from failure to lock the incoming signal in one experiment. In step 150, it is determined that a rotation operation is determined because the point 201 having coordinates (−1, −1) and representing the failed experiment with parameters (230, 9.25) is in a corner region, e.g. a region near a corner point, as indicated by a right-triangle-like region 250 with the point 201 at the right angle, of the distribution pattern in the parameter space. Specifically, the corresponding values of the first and second parameters of the failed experiment, e.g. (230, 9.25), are substantially at ends of the first and second ranges, respectively.

According to step 160, all values of a first parameter and a second parameter for the second set of experiments in FIG. 5 are provided based on the distribution pattern of the first set of experiments in a rotated parameter space, as indicated in FIG. 5, with the perpendicular axes 310 and 320 for the first and second parameter X₂₁ and X₂₂ in the rotated parameter space. The rotated parameter space results from a rotation of the parameter space with axes X₁ and X₂ about the origin, i.e. the central point of the distribution pattern, by a rotation angle of 45° counterclockwise, for example, as illustrated in FIG. 5. In obtain to maintain the same range of X₁ for the values of parameters in the second set of experiments as those in the first set of experiments, the values of points in the rotated parameter space in FIG. 5 are contracted.

For example, the values of points in FIG. 5 are proportionally scaled down with respect to the parameters X₂₁ and X₂₂ of the rotated parameter space to make the respective ranges of the values of points being in the normalized range of [−1, 1]. In this way, the distribution pattern of the first set of experiments as shown in FIG. 2 is mapped to a distribution pattern as shown in FIG. 5. The second set of experiments is determined according to the distribution pattern in FIG. 5. The values of actual parameters of the second set of experiments can be derived from the distribution pattern in FIG. 5, using the first and second ranges of the actual parameters in TABLE I. Moreover, in the above example, the number of the second set of experiments has the same number of the first set of experiments.

Step 170 is then performed to determine a second set of experiments according to the rotated parameter space as shown in FIG. 5 in order to avoid at least the failed experiment, i.e. not taking an experiment substantially with the values of the first and second parameters as about 230 and 9.25 respectively. In order words, the corner 201 and the corner region 250 about the point 201 are to be avoided substantially in the distribution pattern of the second set of experiments. Thus, the second set of experiments is determined as indicated in FIG. 5, according to step 170. As compared to the first set of experiments represented in FIG. 2, the distribution pattern of the second set of experiments avoids the four corners, as corners 201-204 in FIG. 2, as well as the corner regions about the four corner points, such as corner region 250 in FIG. 2. In addition, four points, not included in FIG. 2, are present in FIG. 5, such as points 401-404. Further, the values of all these points in FIG. 5 are kept in the normalized ranges, i.e. [−1, 1] for both two parameters.

According to the embodiments of the invention, a method for determining optimal operating parameters for reading or writing a storage medium, such as recordable Blu-ray discs, is provided. A new set of experiments is generated according to the previous set of experiments, based on a new defined parameter space with respect to the two parameters in order to avoid the invalid characteristic measurement in the previous set of experiments. The new set of experiments generated in this way is expected to result in more reliable operating parameters than the previous set of experiments in finding optimal operating parameters.

In addition, in one example above, a wide as possible parameter range is preferred and kept in the new set of experiments to enable the method of determining operating parameters to find the optimal parameter setting. In addition, if the previous set of experiments having a sufficient large range, the new set of experiments can also keep such range that is needed to obtain enough dynamics range in the resulting characteristic measurement values.

Moreover, operating parameters other than the write strategy parameters, power P and pulse width T_{MP}_{_{—}}_{P}, taken in the above example, or combinations of them, can also be taken in determining optimal operating parameters for writing or reading a storage medium. For example, operating parameters such as servo parameters, for example the focus offset and the spherical aberration, are used for optimizing the reading performance. A characteristic measurement value, such as HF-jitter value, will be measured under the combination of these two operating parameters for finding the optimal operating parameters.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for determining a set of experiments in finding optimal operating parameters for reading or writing a storage medium, the method comprising:
for a first set of experiments in a parameter space with respect to a first parameter and a second parameter, determining a set of characteristic measurement values according to an incoming signal from the storage medium, on which the first set of experiments is performed, and determining whether the characteristic measurement values are valid or not;
if at least one invalid experiment exists in the first set of experiments, where one invalid experiment corresponds to a characteristic measurement value which is invalid, generating a second set of experiments according to the first set of experiments in order for the second set of experiments to exclude the at least one invalid experiment, the generating step comprising:
determining at least one search operation according to distribution of the at least one invalid experiment in the parameter space in order to map the parameter space onto a new parameter space; and
generating the second set of experiments on the new parameter space so that the second set of experiments excludes the at least one invalid experiment.

2. The method according to claim 1, wherein the first set of experiments has a distribution pattern in the parameter space and the step of determining at least one search operation comprises:
determining whether the at least one invalid experiment is substantially in a corner or an edge of the distribution pattern of the first set of experiments.

3. The method according to claim 2, wherein the step of determining at least one search operation further comprises:
if the at least one invalid experiment is substantially only at least one corner of the distribution pattern of the first set of experiment, determining that the at least one search operation includes a rotation operation to rotate the parameter space by an angle so that the new set of experiments on the new parameter space excludes the at least one invalid experiment.

4. The method according to claim 2, wherein the step of determining at least one search operation further comprises:
if the at least one invalid experiment is substantially on an edge of the distribution pattern of the first set of experiment, determining that the at least one search operation includes a shift operation to shift the parameter space by a distance in a direction away from the edge so that the new set of experiments on the new parameter space excludes the at least one invalid experiment.

5. The method according to claim 2, wherein the step of determining at least one search operation further comprises:
if a sufficient dynamic range is found for one of the first and second parameters and the at least one invalid experiment is substantially on an edge of the distribution pattern of the first set of experiment and the edge is substantially parallel to an axis of the other one of the first and second parameters in the parameter space, determining that the at least one search operation includes a contraction operation to contract the parameter space by a ratio in a direction away from the edge so that the new set of experiments on the new parameter space excludes the at least one invalid experiment.

6. The method according to claim 1, wherein the first set of experiments has a distribution pattern in the parameter space and the step of determining at least one search operation comprises:
determining the location of the at least one invalid experiment with respect to the distribution pattern; and
selecting at least one search operation from a plurality of predetermined operations according to at least the location of the at least one invalid experiment in order to map the parameter space onto the new parameter space on which the second set of experiments is based.

7. The method according to claim 6, wherein the step of determining at least one search operation further comprises:
analyzing valid experiments in the first set of experiments, wherein each valid experiment correspond to a characteristic measurement value that is valid;
wherein at least one search operation is selected from the predetermined operations according to the location of the at least one invalid experiment and the analysis of the valid experiments.

8. The method according to claim 6, wherein the predetermined operation comprises at least one of a shift operation, a contraction operation, and a rotation operation.

9. The method according to claim 6, wherein the predetermined operation includes a shift operation to shift the parameter space by a distance in a direction away from the edge so that the new set of experiments on the new parameter space excludes the at least one invalid experiment.

10. The method according to claim 6, wherein the predetermined operation includes a contraction operation to make a dynamic range of one of the first and second parameters smaller in the new parameter space.

11. The method according to claim 6, wherein the predetermined operation includes a rotation operation to rotate the parameter space by an angle so that the new set of experiments on the new parameter space excludes the at least one invalid experiment.

12. The method according to claim 1, wherein the first set of experiments has a distribution pattern in the parameter space, and the distribution pattern is substantially evenly-spaced points in a rectangular region the parameter space.

13. The method according to claim 1, wherein the first set of experiments has 9+4n experiments, where n is a non-zero integer and the first set of experiments are used in a design of experiments method.

14. The method according to claim 1, wherein the first set of experiments and the second set of experiments have the same number of experiments, and the first and the second sets of experiments are used in a design of experiments method.

15. The method according to claim 1, wherein the characteristic measurement value with respect to one of the first set of experiments is invalid if the received signal cannot be locked.

16. The method according to claim 1, wherein the first and second parameter are write strategy parameters.

17. The method according to claim 1, wherein the first and second parameter are servo parameters.

18. The method according to claim 1, wherein the storage medium is a Blu-ray disc.

19. A method for determining optimal operating parameters for reading or writing a storage medium, the method comprising:
(a) determining a first set of experiments with respect to a first parameter and a second parameter, each of the first set of experiments being associated with values of the first and second parameters;
(b) performing each of the first set of experiments by setting of the associated values of the first and second parameters;
(c) for a first set of experiments in a parameter space with respect to a first parameter and a second parameter, determining a set of characteristic measurement values, and determining whether the characteristic measurement values are valid or not;
(d) if at least one invalid experiment exists in the first set of experiments, where one invalid experiment corresponds to a characteristic measurement value which is invalid, generating a second set of experiments according to the first set of experiments in order for the second set of experiments to exclude the at least one invalid experiment, the generating step comprising:
determining at least one search operation according to distribution of the at least one invalid experiment in the parameter space in order to map the parameter space onto a new parameter space; and
generating the second set of experiments on the new parameter space, wherein the first set of experiment is mapped onto the new parameter space according to the at least one search operation so that the second set of experiments excludes the at least one invalid experiment.
(e) performing the second set of experiments on the storage medium and obtaining characteristic measurement values for the second set of experiments; and
(f) determining optimal operating parameters with respect to the first and second parameters according to the characteristic measurement values for the second set of experiments.

20. The method according to claim 19, wherein the determining at least one search operation includes selecting at least one search operation from a plurality of predetermined operations, and the predetermined operation comprises at least one of a shift operation, a contraction operation, and a rotation operation.

21. The method according to claim 19, wherein the determining at least one search operation includes selecting at least one search operation from a plurality of predetermined operations, and the predetermined operations include a shift operation to shift the parameter space by a distance in a direction away from the edge so that the new set of experiments on the new parameter space excludes the at least one invalid experiment.

22. The method according to claim 19, wherein the determining at least one search operation includes selecting at least one search operation from a plurality of predetermined operations, and the predetermined operations include a contraction operation to make a dynamic range of one of the first and second parameters smaller in the new parameter space.

23. The method according to claim 19, wherein the determining at least one search operation includes selecting at least one search operation from a plurality of predetermined operations, and the predetermined operations include a rotation operation to rotate the parameter space by an angle so that the new set of experiments on the new parameter space excludes the at least one invalid experiment.

24. The method according to claim 19, wherein the first and second parameter are write strategy parameters.

25. The method according to claim 19, wherein the first and second parameter are servo parameters.
